(19) United States
(12) Patent Application Publication
(10) Pub. No.: US 2015/0246453 A1
(43) Pub. Date: Sep. 3, 2015

(54) BUTTER TOOL

(71) Applicant: Robinson Home Products Inc., Williamsville, NY (US)

(72) Inventors: Lou Henry, Scarsdale, NY (US); John Healy, Brooklyn, NY (US)

(73) Assignee: Robinson Home Products Inc., Williamsville, NY (US)

(21) Appl. No.: 14/193,580

(22) Filed: Feb. 28, 2014

(51) Int. Cl. B26B 11/00

(52) U.S. Cl. CPC B26B 11/006

(57) ABSTRACT

A butter tool comprising a handle, a blade having a cutting edge, substantially flat sides and a top surface, a plurality of portion indicators corresponding to portion amounts, and a plurality of bristles. The bristles are preferably flexible, individually formed, heat resistant and extend outwardly from a terminal end of the blade.

### FIELD OF THE INVENTION

The present invention relates to a kitchen device, and more specifically to a tool specially designed for use with butter.

### BACKGROUND OF THE INVENTION

Kitchen utensils, such as butter knives, only are so effective when used with butter for cooking purposes. Although there are various aspects of butter use in the kitchen, a butter knife is fairly limited to cutting a portion of butter from a stick of butter and spreading it on a piece of bread or scraping it into a pot or pan and moving it somewhat before it becomes too small to manipulate with the butter knife.

In this regard, when using a butter knife to deposit a portion of butter onto a hot pan or griddle, it is difficult to spread the butter evenly on the hot surface. The best that can be achieved is by using a large portion, which is usually not desired for use in a smaller pot or pan, and moving it around on the cooking surface with the tip of the butter knife. However, this becomes difficult when the butter portion is small, such that good coverage of the cooking surface is difficult to achieve without scraping the butter knife on the cooking surface.

Of course, a brush, paper towel or other material may be used to spread butter on a hot cooking surface, but this is often impractical and requires additional items that then need to be disposed of or individually washed. Moreover, depending on the heat of the cooking surface, some materials are not suitable since they may melt or burn or otherwise scratch the cooking surface, which may be treated with a non-stick coating.

Additionally, a cook using butter often relies on the markings on packaging of individual sticks of butter to measure the portion sizes for use in a recipe. However, there are times when a cook uses butter from an unwrapped stick of butter during cooking, such that the packaging having the portion markings is not available.

In light of the above, it would advance the art to have a single device to deal with the essential aspects of using butter during cooking or baking.

### SUMMARY OF THE INVENTION

The deficiencies in the art are addressed by the present invention, which is directed to a butter tool comprising a handle, a blade having a cutting edge, substantially flat sides and a top surface, a plurality of portion indicators corresponding to portion amounts, and a plurality of bristles.

The cutting edge of the blade is shaped to allow the butter to be cut from a stick of butter and the flat sides may be used to spread the butter on a food item such as a piece of bread. In a preferred embodiment, the cutting edge is sufficiently sharp to permit the user to readily cut through a stick of butter from a refrigerator.

Although the portion indicators may be placed anywhere on the butter tool to easily and quickly provide portion amount measurements, including on the handle or blade, the portion indicators are preferably associated with at least one of the blade sides and/or the blade top surface, and most preferably the blade top surface. The portion indicators are a series of indicators corresponding to portion amounts, which permit the user to measure the desired portion amount on a stick of butter and then use the blade cutting surface to cut the appropriate portion amount from the stick of butter.

In this regard, the portion indicators may comprise notches, raised nibs, or markings that indicate increments, preferably related to tablespoons of butter based on a standard ¼ lb. stick of butter. Once cut, the butter portion can be lifted using one of the flat sides of the blade and placed into a bowl for mixing with other ingredients or onto a cooking surface such as in a pot or pan for cooking.

In the most preferred embodiment, the blade has a terminal end, opposite a first end that is connected to the handle, on which the plurality of bristles are located. The bristles are intended to aid the user in spreading the butter on a surface, and preferably a heated surface such as a griddle or a frying pan, to allow a user to prepare such surfaces for baking or cooking. In keeping, any suitable flexible, elastomeric heat resistant and non-conductive material may be used for the bristles, preferably being heat resistant up to at least 500° F., with silicone based thermoplastic materials being most preferred.

Moreover, the bristles are preferably individual bristles, shorter and thicker than standard basting brush bristles, with spacing between at least some of the individual bristles. This allows the bristles to hold and move a pat of butter that has been cut from a stick of butter about a cooking surface, while being easier to clean. For example, bristles made of a flexible silicone based thermoplastic material having a length of about 1/16 to about ¼ inch, a diameter of about 1/64 to about 1/16 inch and spaces between adjacent bristles 16 being about 1/128 to about 1/32 inch would be preferred for use with the butter tool of the present invention.

The handle can be any type, size and shape, and of any suitable material, as long as it functions to allow a user to hold and manipulate the butter tool as intended. Generally, however, a plastic handle with a generally non-slip surface is preferred for this use. Moreover, a hang hole is preferably included on the handle, most preferably at the terminal end of the handle farthest from the end of the handle that is connected to the blade.

In a preferred embodiment, the handle and blade may be formed of the same material with the bristles co-molded onto the terminal end of the blade. In such an embodiment, the handle and blade may be formed of an injection molded hard plastic material, such as an acrylonitrile butadiene styrene (ABS), with the bristles formed of a silicone based thermoplastic material which is co-molded onto the terminal end of the blade.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a side elevation of a preferred embodiment of the butter tool of the present invention.

FIG. 2 is a top plan view of the preferred embodiment of the butter tool of the present invention shown in FIG. 1.

FIG. 3 is a front perspective view of the preferred embodiment of the butter tool of the present invention shown in FIG. 1.

### DETAILED DESCRIPTION OF THE PREFERRED EMBODIMENT

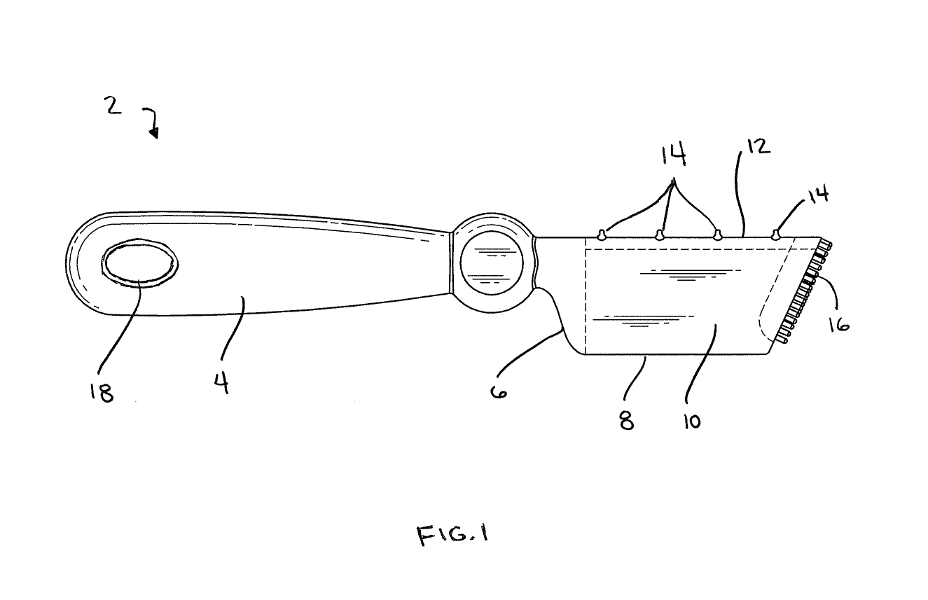

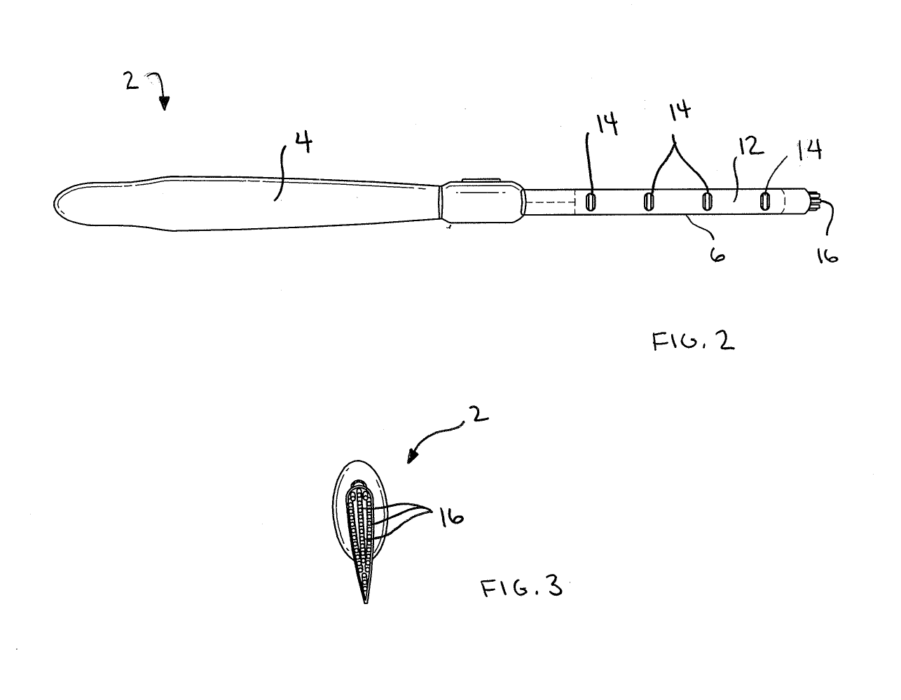

In a preferred embodiment, shown in accompanying FIGS. 1 to 3, the butter tool 2 of the present invention comprises a handle 4, a blade 6 having a cutting edge 8, substantially flat sides 10 and a top surface 12, portion indicator 14, and a plurality of bristles 16.

The handle 4 is preferably sized for a small to average size hand, with the ends of the handle being generally smaller than the middle to contour to a user's hand, and is preferably made from a rigid plastic such as acrylonitrile butadiene styrene (ABS). In the preferred embodiment shown, the blade 6 is made of the same material as the handle 4, so that the handle 4 and blade 6 may be manufactured as a unitary structure or may be formed separately and then connected by any known means. However, the handle 4 and the blade 6 are not necessarily formed of the same material, so long as both are made of suitable materials for the intended purposes. Additionally, a hang hole 18 may be incorporated into the handle 4, if desired, and is preferably incorporated into the terminal end of the handle 4 opposite where the blade 6 attaches to the handle 4.

The cutting edge 8 of the blade 6 is sufficiently long to allow a portion of butter to be cut from a standard ¼ lb. stick of butter, i.e., being greater than the width of a standard ¼ lb. stick of butter, and sufficiently sharp to readily cut through a stick of butter from a refrigerator. The blade sides 10 are sufficiently flat to lift a portion of butter and to spread the butter on a food item such as a piece of bread.

In the preferred embodiment shown, the portion indicators 14 are placed on the blade top surface 12, although such indicators 14 may be placed on, or in addition to, one or more of the blade sides 10 or even the handle 4. Preferably, the portion indicator 14 comprises raised nibs on the blade top surface 12 of the butter tool 2 that may be pressed into the surface of the stick of butter to mark the portion amounts on the butter stick itself. Moreover, the indicators 14 are preferably spaced so as to measure portion amounts in tablespoons on a standard ¼ lb. stick of butter, corresponding to the portion amounts sometimes designated on ¼ lb. butter stick packaging.

The blade 6 preferably includes a truncated terminal end, opposite the end of the blade 6 that is connected to the handle 4, on which the plurality of bristles 16 are located, extending in a direction away from the handle 4. The bristles 16 are preferably made of a flexible, heat resistant and non-conductive material such as a silicone based thermoplastic that is heat resistant up to at least 500° F.

In the most preferred embodiment, the bristles 16 are preferably individual bristles, shorter and thicker than standard natural basting brush bristles, with space between adjacent bristles 16 so that the individual bristles 16 are not in constant contact with one another. The bristles 16 can then hold and move melting butter that has been cut from a stick of butter on a surface, while being easier to clean.

The preferred flexible silicone bristles 16 have a length of about 1/16 to about ¼ inch, with about ⅛ inch being most preferred, a diameter of about 1/64 to about 1/16 inch, with about 1/32 inch being most preferred, and spaces between adjacent bristles 16 being about 1/128 to about 1/32 inch, with about 1/64 inch being most preferred.

Variations, modifications and alterations to the above detailed description will be apparent to those skilled in the art. All such variations, modifications and/or alternatives are intended to fall within the scope of the present invention, limited only by the claims.

We claim:

1. A butter tool comprising:
a handle;
a blade having a cutting edge, substantially flat sides and a top surface;
a plurality of portion indicators corresponding to portion amounts; and
a plurality of bristles.

2. The butter tool of claim 1 wherein the blade further comprises a first end connected to the handle and a terminal end, wherein the bristles are associated with the terminal end of the blade.

3. The butter tool of claim 1 wherein the portion indicator is associated with the handle, the blade top surface, a first blade side, a second blade side or combinations of these.

4. The butter tool of claim 1 wherein the portion indicator is taken from the group consisting of notches, raised nibs and markings.

5. The butter tool of claim 1 wherein the portion indicator comprises raised nibs.

6. The butter tool of claim 5 wherein the raised nibs are on the blade top surface.

7. The butter tool of claim 1 wherein the series of indicator corresponds to portion sizes in tablespoons when measuring a standard ¼ lb. stick of butter.

8. The butter tool of claim 1 wherein the bristles are made of a flexible elastomeric material.

9. The butter tool of claim 8 wherein the flexible elastomeric material is a silicone based thermoplastic material.

10. The butter tool of claim 1 wherein the bristles are individually formed with a space between adjacent bristles.

11. The butter tool of claim 10 wherein the bristles have a length of about 1/16 to about ¼ inch, a diameter of about 1/64 to about 1/16 inch and spaces between adjacent bristles 16 being about 1/128 to about 1/32 inch.

12. The butter tool of claim 2 wherein the bristles extend in a direction away from the handle.

13. The butter tool of claim 1 wherein the handle and blade are formed of the same material.

14. The butter tool of claim 13 wherein the handle and blade are formed of an ABS material.

15. The butter tool of claim 1 wherein the length of the cutting edge of the blade is greater than the width of a standard ¼ lb. stick of butter.

16. The butter tool of claim 1 wherein the handle further comprises a hang hole.
